(19) United States
(12) Patent Application Publication
(10) Pub. No.: US 2013/0007729 A1
(43) Pub. Date: Jan. 3, 2013

(54) Method and System for virtualization assisted remote access system designed For e-Support

(76) Inventor: Alexander Sirotkin, Tel Aviv (IL)

(21) Appl. No.: 12/360,861

(22) Filed: Jan. 28, 2009

Related U.S. Application Data
(60) Provisional application No. 61/080,293, filed on Jul. 14, 2008.

(51) Int. Cl. G06F 9/455; G06F 11/14

(52) U.S. Cl. 718/1; 714/4.4; 714/E11.112

(57) ABSTRACT

A system for remote computer access, for configuration, monitoring and repair, designed for computer technical remote support. A standalone system not affected by operating system (OS) or any other software modules malfunctions which runs in protected environment which enables the system to operate even in the case of severe personal computer (PC) failures, including a loss of network connectivity, operating system (OS) failure to boot and including some hardware failures. A system enabling a remote human technician with an authorization access to the user PC remotely;

### FIELD OF THE INVENTION

This invention is in the field of computers and in particular remote access system designated for technical assistance and repair dedicated to software and hardware of computers, without the need of the professional person to be at the geographic location of the computers

### BACKGROUND OF THE INVENTION

As computer systems become more complex, the average PC user more frequently finds himself facing a problem he cannot solve. Automatic PC repair systems show some promise, but eventually the majority of PC and software problems will have to be solved manually by a technician. As typical technician visit prices are very high, the common solution for home and enterprise support is remote support. Eventually remote support companies need software and hardware tools to do their job and most important they need remote access software. There are many examples of prior art in the remote access market for example VNC, DameWare, pcAnywhere, Citrix Online and WebEx. However, all existing remote access solutions assume that the target PC is functional and has network access. This is hardly the case when PC has a hardware problem, OS fails to boot or some spyware messed up the internet connection, which are all typical cases of support calls.

What is needed is a system of remote access virtualization to overcome these problems of traditional remote access.

What is needed is a system that is not affected by viruses, operating system (OS) failures, user misconfiguration, spyware/malware and many other common problems.

Another common solution to the remote access problem is lights-out management, sometimes called Out-of-band management, which is the use of dedicated management channel and hardware for PC management, support and troubleshooting.

Two typical examples of such systems are Dell Remote Access Card (DRAC) and HP Integrated Lights-Out (iLO). Such systems are usually implemented in a separate hardware component having their own processor, memory, battery, network connection, and access to the system bus. This hardware card provides complete control of the computer remotely. However, these cards are rather expensive and often vendor specific and therefore are used almost exclusively in high-end servers.

What is needed is an inexpensive software version of the above card designed for desktops and home users.

Virtualization is the abstraction of computer resources. It is usually implemented in software, however recent advances in computer hardware allows to implement it partially in hardware.

A. Hardware x86 Virtualization Overview

Traditional x86 architecture defines four different privilege states called rings. Ring 0 is the most privileged state having full control of the hardware (for instance, only ring 0 can manipulate interrupt vectors) and ring 3 is the least privileged state having maximal hardware protection. OS kernel and device drivers usually run in ring 0 and applications in ring 3

This architecture presents a problem for virtualization which requires that only the hypervisor 6 has full control of the hardware, while multiple (unmodified) operating systems running in virtualized environment should have the illusion of running in ring 0, yet should effectively have less privileges than ring 0 allows

Intel VT (Virtualization Technology) solves this problem by introducing two forms of CPU operation—VMX root and VMX non-root. Both VMX sates support all four rings, however only software running in VMX root ring 0 has full control of the hardware. Software running in VMX non-root is always deprivileged in some way (controlled by the hypervisor), even if it runs in VMX non-root ring 0. Hypervisor usually runs in VMX root mode and virtualized operating systems in VMX non-root. The architecture also defines two new operations—VM entry (transition from VMX root to VMX non-root) and VM exit (transition from VMX non-root to VMX root). VM entry can be executed by the hypervisor at any time and VM exit usually happens when virtualized software tries to access hardware resource it has no privilege to work with. The hypervisor controls VM entries and exits using VM execution control fields. It can define, among other things, what CPU instructions or access to which I/O registers and memory areas trigger VM exit

AMD AMD-V (Pacifica) has a very similar architecture and features

B. Standard Approach to I/O Virtualization

Most existing virtualization systems, including WMware, VirtualPC and VirtualBox deploy emulation approach to I/O virtualization. Each of these systems emulates a specific set of hardware peripherals which is generally different from the real hardware peripherals. This approach proved to be sufficient for server virtualization, but remote support system such as Allosity has to virtualize hardware peripherals that are identical to the real hardware so that the remote technician will be able to troubleshoot the problem (which can be hardware related) in exactly the same environment as the user that experienced it

Another approach which works best for certain server virtualization setups is assignment, which states that each peripheral device is assigned to one and only one virtual OS. This is the method that Intel chose for their Virtualization Technology for Directed I/O (VT-d). While it has its advantages, mainly in terms of performance, it clearly cannot work in the case of home user which usually has only one video and network card Para-virtualization is a software virtualization technique that allows modifications to the virtualized operating system, contrary to emulation or hardware virtualization, which run unmodified guest operating systems. It cannot be used for remote support in its traditional form for the same reason as emulation -because in the general case the technician has to fix the problem on the real hardware

PCI-SIG I/O Virtualization is a new standard which amends the PCI-SIG PCI Express (PCIe) 2.0 specification. According to the PCIe specification any device can implement a number of physical functions (PF) and virtual functions (VF). PCIe device that implements at least two VF will allow implementing full virtualization which solves all the problems of the above methods. However, this method requires widespread (nearly 100%) adoption of PCIe IOV, which is an optional specification, i.e. not all PCIe device automatically support IOV. Future versions of Allosity system will use PCIe IOV when it will be available

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

Contrary to traditional remote access tools, the system of this invention is designed for electronic support (e-Support), that is to say the system will be operational and will provide a remote technician an access to the user PC even in the case of severe failures, such as loss of network connectivity due to misconfiguration or viruses, OS failure to boot or another problem, including some hardware failures. Contrary to traditional software remote access solutions, which run under the user OS and thus are affected by OS malfunctions, the system of this invention is a standalone system which runs in hardware protected environment and is completely hidden and inaccessible from the user OS. The protection is provided by the virtualization technology of modern processors.

The system of this invention may utilize hardware CPU and I/O virtualization capabilities, such as an Intel VT Extensions, AMD Pacifica technology or equivalent.

Although some computer components support hardware virtualization, most components do not. These components has to be virtualized in software.

The system of this invention has to implement a special virtualization technology. Such virtualization has to present to the OS virtual hardware that is identical to the physical hardware of the PC. This is important because the OS that is being troubleshot has been installed on the real physical hardware, has to continue to work on that physical hardware after the problem is finished and the technician has to inspect the system in its native mode or operation, since the problem maybe hardware related. All virtualization systems that exist today do not fulfill this requirement, which is the reason the system of this invention has to implement a new virtualization system from scratch and cannot reuse any existing system. The system of this invention reveals a unique virtualization method referred to herein as Transparent Virtualization.

Further, this invention concludes in its innovation a system for remote access designed for computer technical e-Support, the system operational and providing a remote human technician with an authorized access to the user PC even in the case of severe failures, such as loss of network connectivity, OS failure to boot, including some hardware failures; a standalone system not affected by OS malfunctions which run in parallel, in hardware protected environment. The system enabling and comprising the optional use of few special alternative virtualization methods, alternative combination between of them, their combination and their usage for remote access and e-support as follows:

at least a part of method and system that uses virtualization for support and remote access; Remote access system implemented in the hypervisor that executes the operating system that is being accessed remotely in virtual machine, implemented in either software, hardware, or combination of both.

At least a part of method and system that uses transparent virtualization system, i.e. system in which virtual hardware is identical to the physical one;

Transparent virtualization software allows to execute OS in virtual machine which is identical to physical hardware. In particular, such virtualization software allows execution in virtual machine of OS that was initially installed on physical hardware.

At least a part of method and system that uses transparent virtualization system, that can migrate the operating system from physical hardware to the virtual machine. In particular, it is to be done by enabling and disabling virtualization capabilities of the hypervisor in run-time.

at least a part of method and system that uses virtualization that deploys combination of two different virtualization approaches at different times, for example emulation and para-virtualization or assignment and para-virtualization. In particular, virtualization software that changes virtualization modes (from emulation to para-virtualization or from assignment to para-virtualization) in run-time.

At least a part of method and system that uses I/O redirection using virtualization, for instance video and keyboard/mouse I/O redirection. In particular system that uses transparent virtualization for I/O redirection.

At least a part of method and system that uses network adaptor sharing using virtualization; Network adaptor virtualization that uses the combination of assignment and para-virtualization approaches. Assignment is used at the initialization stage and is re-placed by para-virtualization later, when OS successfully initializes. Network para-virtualization can be implemented for instance (in case of Windows OS) by intercepting network packets using NDIS Intermediate driver. The approach, however, is not limited to any particular operating system. The system can switch virtualization modes in run-time more than once.

at least a part of method and system that uses network adaptor sharing between the hypervisor and the virtualized OS or between a number of virtualized operating systems that uses the network adaptor.

At least a part of method and system that uses monitor virtualization that combines emulation and para-virtualization approaches. Emulation is used at the initialization stage and is replaced by para-virtualization later. In case of Windows OS monitor para-virtualization can be implemented for instance by intercepting graphical updates at GDI level, however the system is not limited to Windows. The system can switch virtualization modes in run-time more than once.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

The system of this invention is designed for e-Support, that is to say: the system will be operational and will provide a remote technician with access to the user PC even in the case of severe computer failures, such as loss of network connectivity due to misconfiguration or viruses, OS failure to boot or another problem, including some hardware failures. Contrary to traditional software remote access solutions, which run under the user OS and thus are affected by OS malfunctions, the system of this invention is a standalone system which runs in hardware protected environment, making it completely hidden and not accessible from the user OS. The protection is provided by the virtualization technology of modern processors, as illustrated in FIG. 2.

The system of this invention is implemented in software, however it can also use an optional additional network card for reliable, i.e. out-of-band, communications.

From the user perspective, the system of this invention has two different modes of operation.

In the first mode the system of this invention is only executed when the user encounters a problem and calls for support.

In this first mode the user will have to reboot his operating system and the—system of this invention will be executed from either hard drive system partition or some kind of removable media (CD/DVD-ROM, USB disk-on-key, and the like).

After the problem is fixed by a remote technician the user will reboot the system once more and it will come up in its normal mode of operation without the system of this invention

In this invention one can notice that a virtualization e-system is a parallel system to the existing system of the user computer and software. Getting in and out access for the remotely professional

In the second mode the system of this invention will always be resident in computers memory, but will not be active most of the time. The system will only be activated when the user needs support and deactivated after the problem is fixed. The advantage of this second mode is the fact that the system does not have to be rebooted. The disadvantage is that it may introduce some performance overhead and also potential privacy concern for the user.

When the system of this invention is active, the user OS will be executed in virtualized hardware environment, as illustrated by FIG. 2. This introduces a requirement for the virtualization mode that system of this invention has to implement. Such virtualization has to present to the OS virtual hardware that is identical to the physical hardware of the PC. This is important because the OS that is being troubleshot has been installed on the real physical hardware, has to continue to work on that physical hardware after the problem is finished and the technician has to inspect the system in its native mode or operation, since the problem maybe hardware related.

All virtualization systems that exist today do not fulfill this requirement, which is the reason the system of this invention has to implement a new virtualization system from scratch and cannot reuse any existing system.

The system of this invention reveals a unique virtualization method referred to herein as Transparent Virtualization.

As all typical remote access systems, system of this invention consists of the following modules:
Remote connectivity
I/O (input/output) redirection
Main module
Remote console

Allosity modules are illustrated by FIG. 3.

Remote connectivity module provides the communications channel between the user PC and the remote technician, I/O redirection allows for the remote technician to interact with the OS as if he had physical access to the machine.

The main module binds it all together. Remote console is used by the remote technician to interact with the user PC. Virtualization, which is usually not part of the remote access system, is used by both I/O redirection and main modules.

The main module of this invention is responsible for initialization and execution of the other modules and the user OS, which will be based on either a striped-down version of Windows XP, Linux or other OS (this OS should not be confused with the user OS). In addition to this “generic OS” the system will run a number of applications and device drivers that will implement the system's functionality as defined below.

This invention should be able to boot from read-only media such as CD/DVD-ROM, although it can be executed from other devices, such as system partition of the hard drive or USB disk on key.

In the first mode of operation, when the system of this invention is executed after the user encounters the problem and reboots the PC, the main module will perform the following operations during boot:
Initialize the hardware.
Establish internet connection.
Connect to the remote technician console.
Initialize CPU virtualization extensions and run user OS under virtualization.
Redirect (using I/O virtualization) OS video, keyboard and mouse devices to the remote console.

In the second mode of operation, when the system of this invention is always present in the memory and activated when the user needs support, it will perform a subset of the above operations, namely:
Initialize the hardware
Initialize CPU virtualization extensions and run user OS under virtualization

This invention will initialize only the minimal set of hardware that it needs, namely—CPU, network and video devices. All other peripherals will be initialized (and owned) by the user OS. Keyboard and mouse will be initialized by the user OS, but will not be owned completely by the OS—the system of this invention will have to virtualize these devices for I/O redirection.

Connectivity, I/O redirection and user OS execution under CPU virtualization are explained below in their corresponding sections.

CPU virtualization requires hardware support—Intel CPU with VT (Vanderpool), AMD CPU with AMD-V (Pacifica) or equivalent. For a short description of x86 virtualization technology, including definitions of the terms used below, see background of invention. In order to support Intel, AMD or any other processor this invention uses virtualization instructions via virtualization abstraction layer. The system of this invention will act as a hypervisor, which means (using Intel virtualization terminology) the system will run in VMX root mode and will have full control of the hardware. User OS will be the only OS running under virtualization, that is, VMX non-root mode. The virtualization is initialized by using VMXON instruction and will execute user OS on virtual machine using VMLAUNCH instruction. User OS will be deprivileged of certain access rights depending on the mode of operation, as described below.

When this invention is active, which is either when it is executed in the first mode or when it is activated when running in the second mode, the system will configure VM execution control fields so that each access of the user OS to the resources (memory, I/O and interrupts) of the devices that are owned by the system for example, the network, video, keyboard and mouse, will trigger a VM exit.

This will allow for the system to redirect I/O to/from these devices to the remote console and also protect the devices that should not be accessed by the user OS. Apart from the above protection of the specific peripherals VM should be configured so that the number of VM exits would be minimal by trying to virtualize as little as possible, exploiting the fact that only one user OS (one VM) will be running at a time.

When the system of this invention is loaded but not active, that is, in the second mode, VM will be configured to even lesser amount of potential VM exits. None of the devices that are virtualized when the system is active should be virtualized in this state, so that user OS should have full access to network, video and mouse devices. Keyboard should be virtualized to allow run-time activation.

The system could be activated according to user request, for instance when the user hits a specific key combination. As keyboard resources are virtualized, i.e. access to them causes VM exit, and the system will be able to detect this key combination and switch to a full mode.

During the switch, the system of this invention will perform all initialization steps that where skipped in the second mode, namely:
Establish network connection, including internet configuration and authentication with the Internet Service Provider (ISP)
Connect to the remote technician console or go into passive “listening” mode and wait for remote technician connection.
Redirect (using I/O virtualization) OS video, keyboard and mouse devices to the remote console.

When the problem is fixed, the system of this invention would be deactivated, following either user request (the user would have to hit the above key combination again) or by the remote technician.

For remote connectivity the system of this invention will either use a separate network card or, if it is not present, will share a network card with the user OS. It must be noted that although the former method is slightly more expensive, it is significantly more reliable and should be the preferred connectivity method.

Provided network infrastructure (ADSL, DOCSIS, Ethernet or similar) connectivity is working (broadband connection is described in more detail below), the system will connect to the Internet using its own Internet provider account (if needed). This step may not be required for corporate and some home customers. This is important as the system may not be able to rely on users Internet provider (PPPoE, L2TP, etc) configuration. After connection to the Internet is established, the system will connect to the remote technician console using TCP (or HTTP) protocol and start forwarding I/O (video, keyboard and mouse) redirection information between the user OS and the remote console.

The user PC may be connected to the network modem/router via either Ethernet or USB. Another option is a dialup or other internal PCI modem. In some cases (when it is not a USB device; described in detail below) this device can be shared between the operator of the system and the user OS. However, the preferred connectivity option is to use a separate device.

In this mode the software of this invention should be bundled with an additional hardware component—either dialup modem or Ethernet card. If the user is connected to the internet via broadband modem/router with only one Ethernet port this port will have to be connected to a hub in order to allow connection of the two Ethernet adaptors, that of the user and that of the system.

Regardless of the type of device used for out-of-band communications this device would be protected and completely hidden from the user OS; the system of this invention will configure VM execution control fields so that all resources of that device, namely memory, I/O registers and interrupts, will not be accessible by the user OS. Ideally it should be hidden from the PCI driver during PCI enumeration process of the user OS. The system of this invention will initialize this network device and use it for communications in the usual manner.

In case the user has only one Ethernet network card, Wi-Fi, dialup modem or any other PCI network device this device can be shared between the system and the user OS. The system will use a special virtualization method to implement network device sharing. The method is in fact a combination of two different virtualization techniques which will be used at different stages of the bootstrap process, as described below.

At the beginning, during boot process, the network card will be assigned to the system of this invention. The assignment is a simple virtualization technique in which each hardware device is assigned to one software entity only.

The system of this invention will have full control of the network card and will use it to transfer information to/from the remote console. In order to be able to use any network card the system will have a large database of preinstalled drivers for all existing network devices. Alternatively, when the system of this invention is preinstalled on user's system, the technician that installs the system should ensure that it has the proper network device driver, if network sharing is enabled.

Once the user operating systems boots the network card will have to be shared between the system and the OS. This can be implemented in two different ways. Both options are similar in that they use two different virtualization methods (paravirtualization and assignment) at different times.

In the first option, from the moment the user OS tries to initialize the network card it will be assigned to the user OS and the system of this invention will stop using this hardware device directly.

After the network device successful initialization by the user OS the system of this invention will forward all the system's traffic, that is to say, communications with the remote console, via the user OS. This will be done through a Network Driver Interface Specification (NDIS) intermediate driver. The NDIS is an application programming interface (API) for network interface cards. The NDIS intermediate drivers interface between upper-level protocol drivers and miniport drivers. A mini-port driver is a network device driver in NDIS terminology.

This communications channel will be tested by the system of this invention by trying to establish communications with remote server and if it fails the system will assume that the user OS failed to initialize the network card successfully and will fall back to the first mode, that is, it will assign the card to the system of this invention and will prevent the user OS from accessing it using virtualization extensions by configuring the memory address and other resources as inaccessible for unprivileged software running in VMX non-root mode. If initialization succeeds the OS will continue to work with the network card in the normal manner and it will be shared with the system of this invention. The advantage of this method is that it is relatively simple to implement, however it has a big disadvantage of introducing some, although very small, dependency of the system of this invention on the user's potentially faulty OS.

In the second option, the network card will be first assigned to the system of this invention and then to the user OS when the OS first tries to initialize the network card just as in the first option. However, the assignment will only be temporary. After the OS finishes network card initialization the card will be assigned again to the system of this invention and the OS will not be able to access it directly. The system of this invention will configure the network adaptor's memory address and other resources as inaccessible for unprivileged software running in VMX non-root mode. The system of this invention will temporary install NDIS Intermediate driver that will be used to intercept all packets that the user OS is going to send to the network card, as illustrated by FIG. 4. These packets will be forwarded to the system of this invention via proprietary interface and forwarded to the outside worlds, like Internet, via the network card. In order for this method to work the virtualization system of will have to prevent the network driver of the user OS from running. Preventing it from accessing the hardware (as described above) may not be enough as some drivers may implement a watchdog mechanism, which may assume that non-responding hardware has to be reset and re-initialized. In order to disable the network driver the system of this invention may, for instance, try to find all memory pages that contain the drivers code and mark them as inaccessible by the unprivileged code of the OS. This way, the execution of any code that belongs to the driver (including potentially problematic watchdog) will be prevented—and the system of this invention will receive an exception (VM exit) when this code will try to run and will emulate its successful completion without letting the code actually run. Another option can be to (temporary) replace the network adapter's driver with a “fake” device driver having the same name and interface, which will make the user OS believe that the hardware initialization succeeded; this driver will not access the hardware at all, but will forward all sent and received packets between the user OS and the system of this invention.

The NDIS (miniport or intermediate) driver mentioned above will be used to implement para-virtualization as mentioned above and will have the following functionality:
It will be installed into the user OS by the system of this invention in run-time when needed, exploiting the fact that the system of this invention has full access to the OS and the hard drive it resides on. It will be deleted or disabled when no longer needed, like when the problem is solved and the OS boots in it's normal mode, not under virtualization.
It will implement a communications channel with the system of this invention, i.e. hypervisor. This channel will be used for management, for instance enable/disable commands and also for sending packets to/from OS. This communications channel will be implemented using well-known method of buffer descriptor (BD) ring in a shared memory region that will be accessible by both the system of this invention and the OS.
In the first option it will implement the following packet forwarding functionality:
   Receive packets from the system of this invention that are destined to the remote console and send them to the network driver
   Receive packets from the network driver that are destined for the system of this invention and forward them to the destination.
In the second option it will implement the following packet forwarding functionality:
   Intercept packet sent from the OS and forward it to the system of this invention
   Inject into OS network stack packets received from the system of this invention.

The conceptual difference between two modes is illustrated in FIGS. 5 and 6.

For I/O redirection the system of this invention will use a concept of Transparent Virtualization, which is a unique virtualization approach developed specifically for the needs of remote support, however it may be used in other areas as well.

As such, Transparent Virtualization presents to the user OS running in the virtualized environment virtual peripherals which are identical to the real hardware which the user OS works with when running normally, that is, not under virtualization. As mentioned above, apart from the network device that has to be virtualized in some cases, this invention virtualizes video, keyboard and mouse devices. All other hardware components like disk drive, DVD, USB, printer and sound will be assigned to the user OS, who will continue to work in the usual manner.

The requirement of “transparent” virtualization makes the above virtualization approach very different from what is generally accepted in virtualization systems such a VMware, which means that the system of this invention cannot use any of the available virtualization packages. E-support requires this unique virtualization because:
In all virtualization scenarios deployed today the virtualized OS is installed under virtual machine from the beginning, that is, the OS always runs on the same virtual hardware. In the case of eSupport of this invention, the OS will be initially installed on the real hardware and later run on the virtual hardware, which naturally has to be identical to the physical one.
Remote technician has to troubleshoot the problem on the real hardware, because the problem may be hardware related.
Windows activation and other software packages which are hardware dependent may not function as expected if virtual hardware is different from the physical one.

The system of this invention virtualizes video adapter in order to show the technician working at the remote console the exact copy of what is displayed on the monitor. Contrary to standard remote access tools, it has to show the monitor image not just during normal OS operation, but also during boot and OS error state, i.e. “blue screen”. It does so by intercepting OS access to the video adaptor using virtualization, as illustrated in FIGS. 7 and 8.

The interception mechanism works differently depending on the video mode of the OS and the adaptor. It distinguishes between “standard” VGA mode, which is the video mode of the video adaptor during boot, OS errors, “blue screen”,“Safe Mode”, etc and “accelerated” mode, which is the video mode used by Windows during normal operation.

When video adaptor is in VGA mode the access to video is intercepted at the hardware level. This approach exploits the fact that VGA is a standard video mode and the contents of video memory can be easily interpreted by the remote console without any vendor specific hardware drivers. Whenever the OS updates the image on the screen it writes that image to the video adaptors memory (located, for instance, at the physical address 0xA000 in case of VGA mode 0x13). The system of the present invention would be notified (using VM exit in Intel virtualization terminology) when such write operation occurs at which time the system can read the contents of updated video memory and transfer the contents to the remote console. The system may transfer the updated video memory on each write operation or it can buffer a number of operations and transfer them in one transaction to improve performance. The system may also compress the transferred information to improve the performance even further. Exploiting the fact that the system of the present invention runs in the privileged VMX root mode of the CPU it configures the whole VGA video memory region as inaccessible for unprivileged software, that is the user operating system, which runs in VMX non-root mode of the CPU.

In addition to intercepting write accesses to the video memory, the system of the present invention will have to intercept calls to certain BIOS interrupts. VT extensions allows the hypervisor to receive notification on each interrupt of the virtualized OS. BIOS interrupts are sometimes used to switch different VGA modes (interrupt 0x10), to update indirectly the video memory (interrupt 0x0C), and other video related operations. Whenever the video mode is changed, the system may require to reprogram the virtualization extensions to trigger an exception on an access to different memory region, as different VGA modes work with different video memory segments. It may need to intercept additional interrupts which are relevant to VGA operation. Each intercepted video mode switch has to be transferred to the remote console.

The remote console will have to implement a full VGA simulation. It will use the information received from the remote host running the software of this invention as an input to the VGA simulator, which will be able to display to the technician the exact copy of the virtualized monitor. However, this approach will not work when video mode is not simple VGA. After Windows boot finishes the video subsystem starts to use hardware acceleration and accesses the hardware in very vendor-specific way. If there is interception to the raw access to video memory and transfer contents of the video memory to the remote console, the remote system will not be able to interpret this information. In order to resolve this problem, the system of this invention will switch to a second interception mechanism when the OS will switch the video mode from VGA to any accelerated mode.

Similarly to network device virtualization, the second method uses technique know as para-virtualization, where the system of this invention will install a small software module into the user OS that will intercept video access at GDI level, as illustrated by FIG. 8.

This modification of the user OS will be performed in run-time exploiting the fact that the system of this invention has full control of the user OS. The modification will be temporary and will be removed after support session is finished. Intercepting video access at GDI level will allow remote console to interpret video access regardless of the client video hardware. The remote console software will have to implement a Remote Desktop protocol or simply use a standard remote desktop client.

There is a small probability of an error during the switch from one virtualization mode to another. This switch should be thoroughly tested and special software module could be created that will check in run-time whether the switch succeeded or not. In case of a failure to switch from the first to the second mode, the system should fall back to the first one.

The system should support switching from one video interception mode to another a number of times, as the operating system can switch back and forth between VGA and accelerated modes.

The purpose of keyboard and mouse redirection module is to allow the remote technician to control the user's PC using keyboard and mouse remotely. In other words, it should accept remote keyboard and mouse events and “inject” them into the user's system. This module works differently depending on the type of keyboard and mouse, which can be either PS/2 or USB. It is important to note that both keyboard and mouse will be initialized by the user OS and used in a normal manner. The system of this invention will “inject” additional events received from the remote console into the working system.

For PS/2 keyboard and mouse, the 8042 controller I/O registers will be virtualized in a way described below. The system of this invention will simulate keyboard and mouse events by sending an interrupt to the user OS and then intercepting I/O reads from 8042 registers and substituting the value received remotely, thus emulating keyboard and mouse events.

USB keyboard and mouse I/O redirection will require BIOS support of USB Legacy mode in order to work during boot and also DOS and Windows Safe Mode. When USB Legacy mode is enabled, software accesses the keyboard and mouse devices using I/O ports and interrupts, which are emulated by the BIOS and translated to USB commands. This interface is in fact very similar to PS/2 interface and will be virtualized and redirected in the same way, as described above. After successful Windows boot keyboard and mouse input will be “injected” into the user OS using para-virtualization method, similarly to video virtualization described above. After successful Windows initialization the system of this invention will install a temporary software module into the user's OS that will “inject” keyboard and mouse events received from the remote console As with video redirection, the system of this invention may simply use Windows Remote Desktop when working in this mode. The remote console of this invention is a simple application that communications with the remote access module of the system via TCP (or HTTP) protocol. It implements the other side of I/O redirection, that is, it presents to the technician the image of the user's screen and it sends technicians keyboard and mouse events to the user's OS.

The remote control should also implement a few special commands that will allow the technician to control the system of this invention itself and not the virtualized user OS. The remote console can use standard Remote Desktop Client to implement parts of the above functionality.

What is claimed is:

1. A system for remote computer access, for configuration, monitoring and repair, designed for computer technical remote support. A standalone system not affected by operating system (OS) or any other software modules malfunctions which runs in protected environment which enables the system to operate even in the case of severe personal computer (PC) failures, including a loss of network connectivity, operating system (OS) failure to boot and including some hardware failures. A system enabling a remote human technician with an authorization access to the user PC remotely; the system comprising:
a) A remote access system that provides to remote technician a full access to operating system via standard user interface.
b) A remote access system that runs in parallel layer and independently from the OS and thus not affected by the OS, or any software that runs under the OS, malfunctions.
c) The separation and protection are provided by virtualization technology which hides the remote access software while simulating normal computer environment for the OS.
d) The system of this invention operates in at least one of the two optional modes of operation that this invention offers:
d1) Mode one:
A user encounters a problem and calls for support; A user will reboot the PC; the system of this invention will be executed by a remote technician either from a hard drive or from of removable media—CD/DVD-ROM, USB disk-on-key, and the like; After the problem is fixed by the remote technician he will reboot the system once more and it will come up in its ordinary mode of operation without the system of this invention.
d2) Mode two:
The system of this invention, will always be resident in the user computer memory, but will not be active most of the time the system will only be activated when the user needs support and deactivated after the problem is fixed; the user computer does not have to be rebooted in this mode of operation.

2. The system of claim 1, further comprising a special virtualization method; the virtualization method used by the system presents to the OS virtual hardware that is identical to the physical hardware of the computer. Virtualization method referred to herein as Transparent Virtualization. Transparent virtualization system can virtualize any combination of the following hardware components: CPU, network adaptor, video adaptor, mouse, keyboard, other user input/output system or any other peripheral.

3. A system as in claim 1, wherein the system uses Transparent Virtualization to virtualize some hardware components and traditional virtualization methods, including but not limited to assignment and emulation, to virtualize the additional hardware components.

4. A system as in claim 3, wherein the remote access system of the present invention and the user OS share the same network adaptor for network connectivity.

5. A system as in claim 3, wherein the remote access system of the present invention can use an optional additional network adaptor for network connectivity.

6. A system for remote computer access, for configuration, monitoring and repair, designed for computer technical remote support. A standalone system not affected by operating system (OS) or any other software modules malfunctions which runs in protected environment which enables the system to operate even in the case of severe personal computer (PC) failures, including a loss of network connectivity, operating system (OS) failure to boot and including some hardware failures. A system enabling a remote human technician with an authorization access to the user PC remotely. A system comprising at least a few of the optional alternative virtualization methods, their combination and their usage for remote access and support as follows:
a) At least part of elements mentioned in the method and the system use in their operation virtualization for support and remote access; remote access system implemented in the hypervisor that executes the operating system that is being accessed remotely in virtual machine, implemented in either software, hardware, or combination of both.
b) At list part of the method and the system use in its operation transparent virtualization method, i.e. virtualization method in which virtual hardware is identical to the physical one. Transparent virtualization system can virtualizes any combination of the following hardware components: CPU, network adaptor, video adaptor, mouse, keyboard, other user input/output system or any other peripheral.
c) At least part of the method and the system that uses transparent virtualization system of the previous item (b), can migrate the operating system from physical hardware to the virtual machine. In particular, it can be achieved by enabling and disabling virtualization capabilities of the virtualization hardware and the hypervisor in run-time.
d) At least part of the method and the system that uses combination of two different virtualization approaches at different times, for example emulation and paravirtualization or assignment and para-virtualization, to virtualize a certain computer peripheral.
e) At least part of the method and the system uses virtualization for I/O redirection. In particular video, keyboard and mouse I/O redirection.
f) At least part of the method and the system uses virtualization for network adaptor sharing. In particular network adaptor virtualization that uses the combination of assignment and para-virtualization approaches. Assignment is used at the initialization stage and is replaced by para-virtualization later, when OS successfully initializes.
Network para-virtualization can be implemented for instance (in case of Windows OS) by intercepting network packets using NDIS Intermediate driver. The approach, however, is not limited to any particular operating system. The system can switch virtualization modes in run-time more than once.
h) At least part of the method and the system uses virtualization for monitor redirection. In particular, the combination of emulation and para-virtualization approaches. Emulation is used at the initialization stage and is replaced by para-virtualization later. In ease of Windows OS monitor para-virtualization can be implemented for instance by intercepting graphical updates at GDI level, however the system is not limited to Windows. The system can switch virtualization modes in run-time more than once.

7. A Virtualization method referred to herein as Transparent Virtualization. Transparent virtualization method presents to the OS virtual hardware that is identical to the physical hardware of the computer. Transparent virtualization system can virtualize any combination of the following hardware components: CPU, network adaptor, video adaptor, mouse, keyboard, other user input/output system or any other peripheral.

8. A virtualization method of claim 7, wherein the CPU virtualization is implemented in both software and hardware. In particular using virtualization extensions of modern Intel compatible processors.

9. A virtualization method of claim 7, wherein transparent peripheral virtualization is implemented with the assistance of hardware CPU virtualization extensions. In particular using virtualization extensions of modern Intel compatible processors to prevent direct access of the OS to virtualized peripheral resources, such as memory and registers.
